(19) United States
(12) Patent Application Publication
(10) Pub. No.: US 2013/0125188 A1
(43) Pub. Date: May 16, 2013

(54) MULTIMEDIA PRESENTATION PROCESSING

(71) Applicants: Hiren M. Mandalia, Schaumburg, IL (US); Bhavan Gandhi, Vernon Hills, IL (US); Faisal Ishtiaq, Chicago, IL (US); Renxiang Li, Lake Zurich, IL (US)

(72) Inventors: Hiren M. Mandalia, Schaumburg, IL (US); Bhavan Gandhi, Vernon Hills, IL (US); Faisal Ishtiaq, Chicago, IL (US); Renxiang Li, Lake Zurich, IL (US)

(73) Assignee: GENERAL INSTRUMENT CORPORATION, Horsham, PA (US)

(21) Appl. No.: 13/297,394

(22) Filed: Nov. 16, 2011

(51) Int. Cl. H04N 21/40; H04N 5/93

(52) U.S. Cl. 725/110; 386/241; 386/E05.028

(57) ABSTRACT

Disclosed are methods and apparatus for generating or selecting bookmarks for a multimedia presentation. These bookmarks may be encoded with the multimedia presentation into a multimedia container, which may then be transmitted to an end-user device. Also, these bookmarks may be made available to an end-user device over the Internet. Each bookmark may demarcate a content event and may comprise semantic information for that content event. Bookmarks may be generated automatically (e.g., by performing a media-analysis process) reviewed by a human. The end-user device may use the bookmarks to perform a trick play (e.g., semantic trick play) on the multimedia presentation.

### FIELD OF THE INVENTION

The present invention relates to the processing of multimedia presentations.

### BACKGROUND OF THE INVENTION

The purchase and consumption of media presentations by users (i.e., media consumers) is common. Here, the terminology “media presentation” or “multimedia presentation” is used to refer to any digital content, including but not limited to video, audio, and interactive files. Also, the terminology “consumption” is used to refer to any type of human interaction with a media presentation, including but not limited to watching, listening to, and interacting with.

Typically, a user is able to perform “trick play” (e.g., pause, fast forward, rewind, and skip) during the playback of such media presentations. This trick play facility allows the user to “jump” to different points in the media presentation quickly.

Conventionally, trick play functions are a function of time only. For example, a “skip” function skips playback of the media presentation by a predetermined time period.

### BRIEF SUMMARY

According to aspects of the present invention one or more bookmarks are generated or selected for a multimedia presentation. These bookmarks are encoded with the multimedia presentation into a multimedia container, which may then be transmitted to an end-user device. An operator, or user, of the end-user device may decode the multimedia container and use the bookmarks to perform trick play on the multimedia presentation.

Preferably each bookmark demarcates a content event, i.e., an event in the media presentation that is meaningful in the context of the media presentation (for example, a goal in a soccer match).

According to other aspects of the present invention one or more bookmarks are generated or selected for a multimedia presentation. These bookmarks demarcate a content event in the media presentation and are made available to an end-user device over the Internet such that the user of the end-user device may use the bookmarks to perform trick play on the multimedia presentation which has been streamed to him in an appropriate multimedia container.

In some embodiments, a bookmark comprises a generic semantic label for the content event corresponding to that bookmark. Also, in some embodiments, a bookmark comprises a description of the specific content event corresponding to that bookmark. The semantic information of the bookmark may be used by the user to perform semantic trick play on the media presentation, for example, the user may navigate through the media presentation using salient features of the content as opposed to arbitrary demarcation points. This tends to enable the user to locate a desired playback position in the media presentation relatively quickly (i.e., compared to using conventional trick play methods).

Preferably, the generation of the bookmark is performed by automatic means, e.g., using a media analysis process. In some embodiments the automatically generated bookmarks are reviewed, filtered, or edited by a human (i.e., a human bookmark author). In this way, the workload on the human bookmark author tends to be reduced (compared to if the bookmarks were generated manually), whilst the relevance and accuracy of the automatically generated bookmarks tends to be increased. The bookmarks may be generated in any appropriate way and by any appropriate entity (e.g., a cable head end or creator of the multimedia presentation).

According to other aspects of the present invention a multimedia container is received and decoded by an end-user device. The multimedia container contains an encoded media presentation as well as encoded bookmark information for that multimedia presentation. Thus, the user of the end-user device may use the bookmark information to perform trick play on the multimedia presentation which has been streamed to him in the multimedia container. Preferably the bookmark information comprises demarcations for content events that occur within the media presentation. More preferably the bookmark information comprises respective generic semantic label for the content events. Also, in some embodiments, the bookmark information comprises respective descriptions of the specific content events.

According to other aspects of the present invention, apparatus for providing any of the above aspects is provided.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic illustration (not to scale) showing a TV program in which a semantic bookmark has been inserted;

FIG. 2 is a schematic illustration (not to scale) of an example network in which an embodiment of a method of providing semantic bookmark information for the TV program is implemented;

FIG. 3 is a schematic illustration (not to scale) showing a cable head-end;

FIG. 4 is a schematic illustration (not to scale) showing a set-top box;

FIG. 5 is a process flow chart showing certain steps of an embodiment of a method of providing semantic bookmark information for the TV program, as performed by the elements of the network of FIG. 1;

FIG. 6 is a process flow chart showing certain steps of an example method by which semantic trick play may be performed on the television program;

FIG. 7 is a schematic illustration (not to scale) of a further example of a network in which a further embodiment of a method of providing semantic bookmark information for the TV program is implemented;

FIG. 8 is a process flow chart showing certain steps of a further embodiment of a method of providing semantic bookmark information for the TV program, as performed by the elements of the network of FIG. 7; and

FIG. 9 is a process flow chart showing certain steps of an example method by which semantic trick play may be performed on the TV program using a tablet computer.

### DETAILED DESCRIPTION

In the following description, like reference numerals refer to like elements.

The following description is based on embodiments of the invention and should not be taken as limiting the invention with regard to alternative embodiments that are not explicitly described herein.

The following definitions are useful in the understanding of the below described embodiments.

The terminology “content event” can be used to refer to a point or scene of interest in a multimedia presentation (e.g., a television (TV) program). The point or scene of interest in the multimedia presentation is meaningful in the context of the multimedia presentation. Examples of content events include an action sequence in a movie, a home-run in a televised baseball game, a goal in a televised soccer match, and a commercial break in a TV program.

The terminology “semantic label” can be used to refer to a descriptor or tag (i.e., a descriptive label) that can be used to describe a content event. In other words, a semantic label is a descriptive label that has meaning in the context of the media presentation for which it is used. Examples of semantic labels (corresponding to those examples of content events listed above) include “action scene,” “home-run,” “goal,” and “commercial break.”

The terminology “event description” can be used to refer to relatively detailed information that specifically relates to a certain content event. An event description of a content event typically includes relatively specific and detailed information on that content event, whereas a semantic label for that content event is a more general label. An example event description of the “soccer match goal” content event is “USA scores a goal in the last minute,” whereas the semantic label is “goal.”

The terminology “semantic bookmark” can be used to refer to the combination of a semantic label of a content event and either a demarcation point within the media presentation at which that content event occurs (e.g., as specified by a particular time or frame signature) or a particular segment within the media presentation within which that content event occurs (e.g., as specified by a start time and end time, or frame signatures of the start and end points, of the segment). Optionally, a semantic bookmark may additionally include an event description of the content event. For example, a semantic bookmark of the “soccer match goal” content event is: semantic label=“goal,” time=“start: 89th minute, end: 90th minute,” event description=“USA scores a goal in the last minute.”

Additionally and optionally, a semantic bookmark may contain a Universal (or Uniform) Resource Identifier (URI). A URI is an identifier used to identify a website or a location on a remote server (e.g., on the Internet). The URI may identify a resource that contains additional content (e.g., more detailed descriptions, images, videos, viewing statistics, blogs, user comments, news, critics' reviews, etc.) related to the content event of that semantic bookmark.

The terminology “trick play” can be used to refer to a user manipulating, e.g., pausing, replaying, rewinding, etc., the media presentation. The user may use semantic bookmarks to perform “semantic trick play,” for example, in a TV program the user may skip back to the start of an earlier semantic bookmark and replay the TV program from that earlier point (e.g., in slow-motion).

Apparatus for implementing any of the below described arrangements, and performing any of the below described method steps, may be provided by configuring or adapting any suitable apparatus, for example one or more computers or other processing apparatus or processors, or providing additional modules. The apparatus may comprise a computer, a network of computers, or one or more processors, for implementing instructions and using data, including instructions and data in the form of a computer program or plurality of computer programs stored in or on a machine-readable storage medium such as computer memory, a computer disk, ROM, PROM, etc., or any combination of these or other storage media.

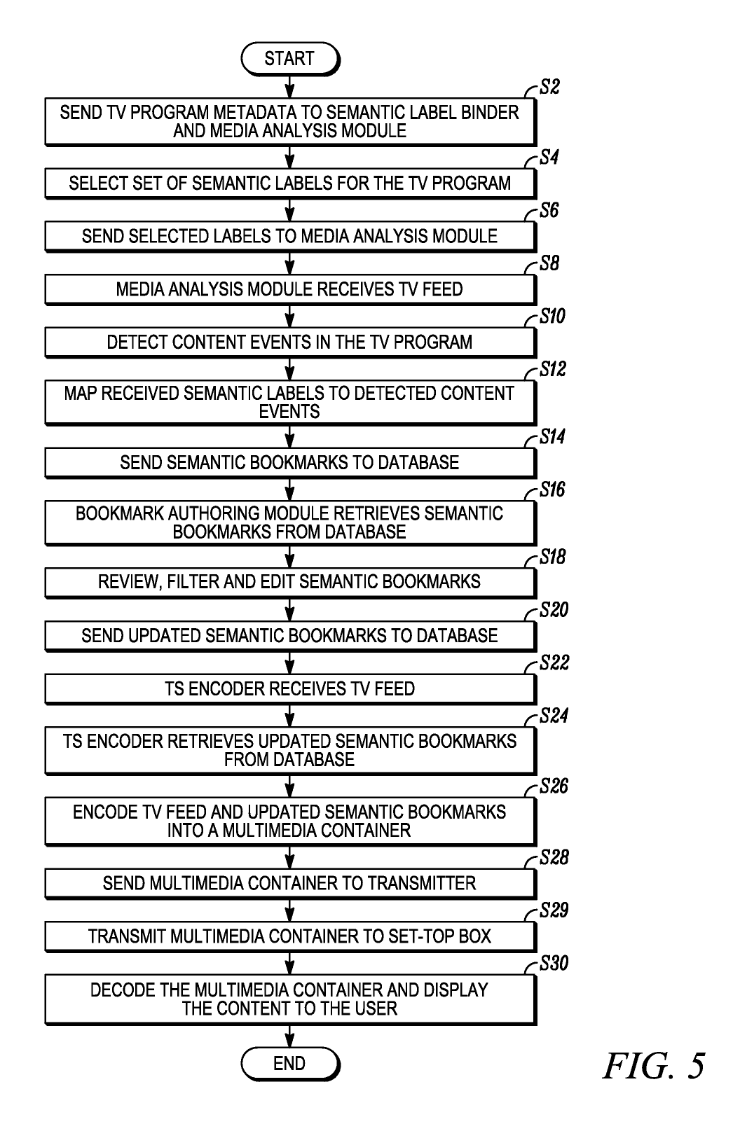

It should be noted that certain of the process steps depicted in the flowcharts of FIGS. 5, 6, 8, and 9 and described below may be omitted or such process steps may be performed in differing order to that presented below and shown in those Figures. Furthermore, although all the process steps have, for convenience and ease of understanding, been depicted as discrete temporally-sequential steps, nevertheless some of the process steps may in fact be performed simultaneously or at least overlapping to some extent temporally.

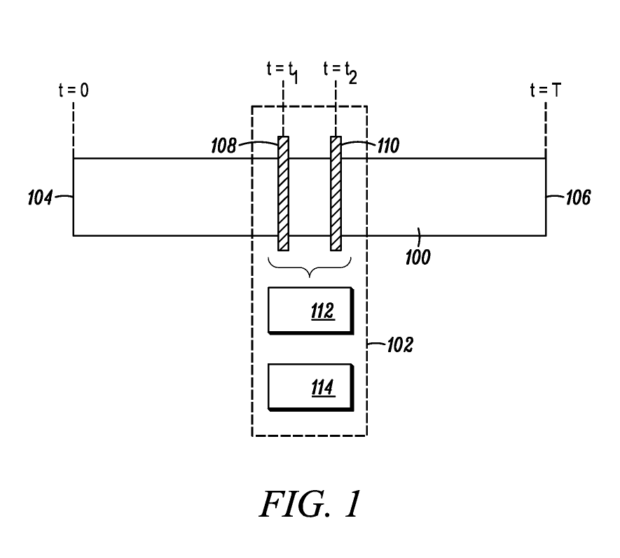

Referring now to the Figures, FIG. 1 is a schematic illustration (not to scale) showing a TV program 100 in which a semantic bookmark 102 has been inserted (e.g., during a below described process).

Although the TV program 100 is used herein to illustrate embodiments of the invention, it will be appreciated that in other embodiments a different type of media presentation/multimedia content (e.g., a radio broadcast) is processed. The multimedia presentation may be consumed by the user using any appropriate device (e.g., a laptop) and which is provided and processed by any appropriate entity using any appropriate process or processes.

The TV program 100 runs from its start time 104 at time t=0 to its end time 106 at time t=T. The semantic bookmark 102 has been inserted into the TV program 100 between the start time 104 and the end time 106.

The semantic bookmark 102 comprises start and end demarcation points (indicated in FIG. 1 by the reference numerals 108 and 110 respectively) for a content event, a semantic label 112 for that content event, and an event description 114 of that content event. The start demarcation point 108 of the content event occurs in the TV program 100 at time t=t₁. The end demarcation point 110 of the content event occurs in the TV program 100 at time t=t₂.

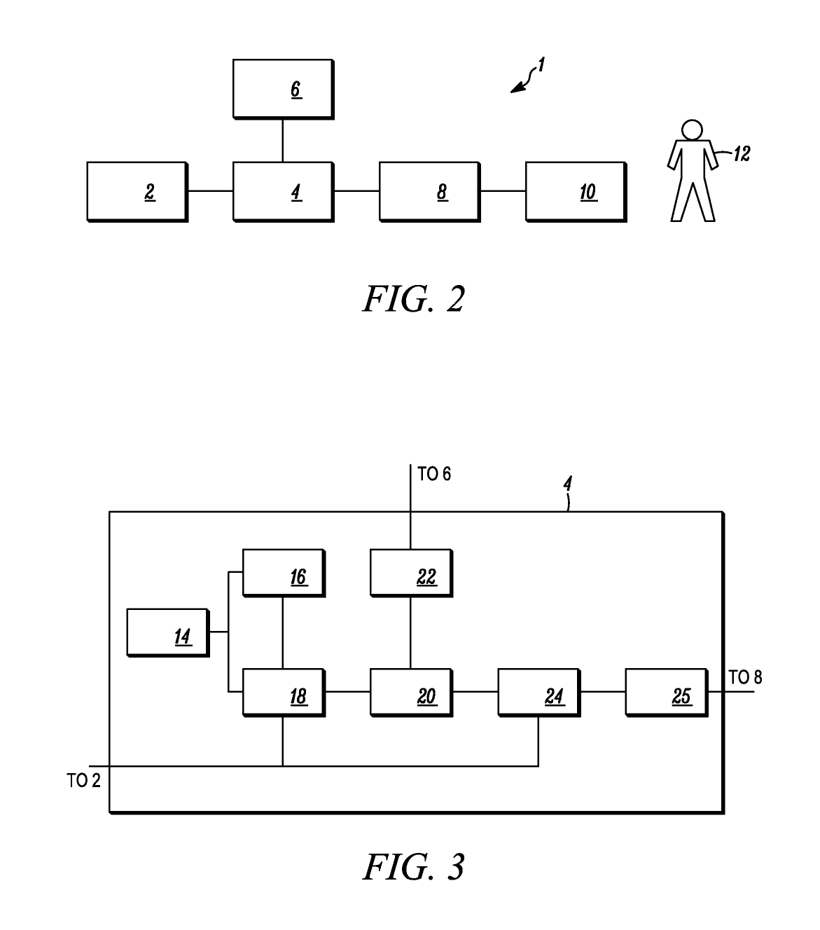

FIG. 2 is a schematic illustration (not to scale) of an example network 1 in which an embodiment of a method of processing the TV program 100 is performed. The embodiment of the method of processing the TV program 100, as performed by the entities of the network 1, is described in more detail below with reference to FIG. 5.

In this embodiment, the TV program 100 is processed to determine one or more semantic bookmarks 102 for the TV program 100, which is then provided to a user, thereby enabling a user to perform semantic trick play. However, in other embodiments, the bookmarks for the TV program 100 are non-semantic bookmarks, i.e., a demarcation point or points within the TV program 100 that do not necessarily relate to a content event within the TV program 100.

The representative network 1 comprises a service operator 2, a cable head-end 4, a bookmark author 6, a set-top box 8, a television (TV) 10, and a user 12.

In this example, the service operator 2 comprises apparatus that provides a television feed corresponding to the TV program 100. The service operator 2 is coupled to the cable head-end 4 (e.g., either by a wireless or wired connection) such that, in operation, the service operator 2 provides the television feed to the cable head end 4.

In this example, the cable head-end 4 is a facility for receiving, processing, and re-distributing television signals (e.g., the television feed). The cable head-end 4 is described in more detail below with reference to FIG. 3. In addition to being coupled to the service operator 2, the cable head end 4 is coupled (e.g., either by a wireless or wired connection) to the bookmark author 6 and to the set-top box 8. In operation, the cable head-end 4 receives the television feed from the service operator 2. The cable head-end 4 then processes the received television feed using input from the bookmark author 6. The cable head-end then distributes the processed signal (encoded in an appropriate multimedia container) to the set-top box 8.

The bookmark author 6 is capable of reviewing, filtering, and editing semantic bookmarks 102 stored within the cable head-end 4. The bookmark author 6 may be a human being, or the bookmark authoring functionality may be provided by a different type of entity or entities (e.g., apparatus for performing automatic bookmark authoring) capable of reviewing, filtering, and editing semantic bookmarks 102.

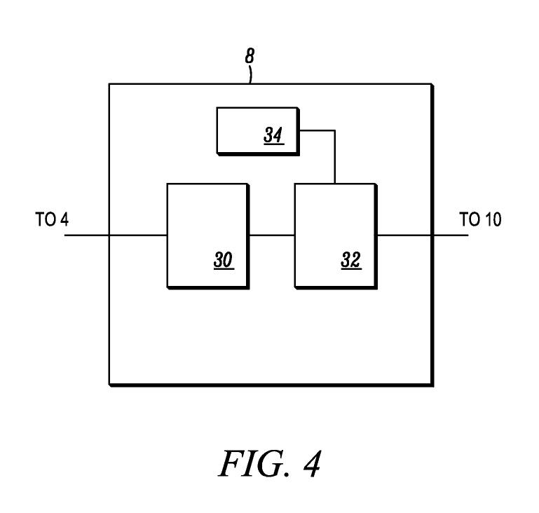

In this example, the set-top box 8 is a device that, in operation, processes a multimedia container received from the cable head end 4 to provide content. The set-top box 8 is also coupled to the TV 10. The set-top box 8 is described in more detail later below with reference to FIG. 4.

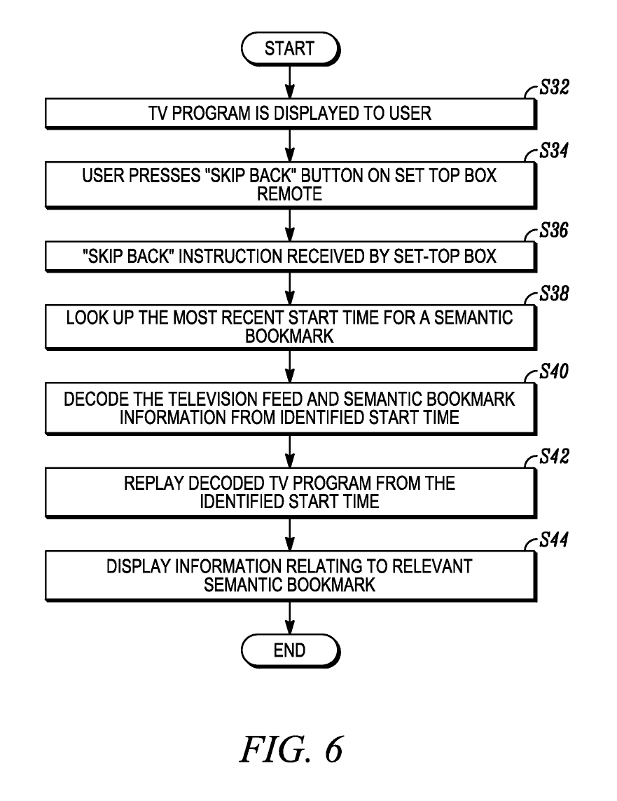

In this example, the TV 10 is a conventional television on which, in operation, content from the set-top box 8 is displayed to a user 12. The user 12 may perform semantic trick play whilst watching content displayed on the TV 10. An example method by which the user 12 may perform semantic trick play on the content displayed on the TV 10 (i.e., the TV program 100) is described in more detail later below with reference to FIG. 6.

FIG. 3 is a schematic illustration (not to scale) showing the cable head-end 4.

The cable head-end 4 comprises an Electronic Program Guide (EPG) service module 14, a semantic label binder 16, a media analysis module 18, a database 20, a bookmark authoring module 22, a Transport Stream (TS) encoder 24, and a transmitter 25.

The EPG service module 14 is a provider of broadcast programming or scheduling information for current and upcoming TV programs. The EPG service module 14 is coupled to the semantic label binder 16 and to the media analysis module 18, such that information may be sent from the EPG service module 14 to each of the semantic label binder 16 and the media analysis module 18.

The semantic label binder 16 is a module that contains a set of semantic labels for each of a plurality of different types of TV programs. In addition to being coupled to the EPG service module 14, the semantic label binder 16 is coupled to the media analysis module 18, such that information may be sent from the semantic label binder 16 to the media analysis module 18.

The media analysis module 18 is for analysing and processing received television feed, programming information, and semantic label information, as described in more detail later below with reference to FIG. 5. In addition to being coupled to the EPG service module 14 and to the semantic label binder 16, the media analysis module 18 is coupled to the service operator 2 such that, in operation, the media analysis module 18 receives the television feed provided by the service module 2. Also, the media analysis module 18 is coupled to the database 20 such that output from the media analysis module 18 may be stored in the database 20, and such that the media analysis module 18 may access information stored in the database 20.

The database 20 is for storing data. In addition to being coupled to the media analysis module 18, the database 20 is coupled to the bookmark authoring module 22 and to the TS encoder 24. This is such that information from each of the bookmark authoring module 22 and the TS encoder 24 may be stored in the database 20, and such that each of the bookmark authoring module 22 and the TS encoder 24 may access information stored in the database 20.

The bookmark authoring module 22 is a facility by which the bookmark author 6 may manage (e.g., add/delete/edit) semantic-bookmark information input to the cable head-end 4. The bookmark authoring module 22 is coupled to the bookmark author 6.

The TS encoder 24 is for encoding information into an appropriate Multimedia Container for transmission to the set-top box 8. In addition to being coupled to the database 20, the TS encoder 24 is coupled to the service operator 2 such that, in operation, the TS encoder receives the television feed provided by the service module 2. Also, TS encoder 24 is coupled to the transmitter 25 such that output from the TS encoder 24 may be delivered to the transmitter 25.

The transmitter 25 is for transmitting information encoded by the TS encoder 24 to the set-top box 8. The transmitter 25 is coupled to the set-top box 8.

FIG. 4 is a schematic illustration (not to scale) showing the set-top box 8.

The set top box 8 comprises a receiver 30, a decoder 32, and a storage 34. The receiver 30 is configured to, in operation, receive a signal transmitted from the transmitter 25 of the cable head-end 4. The receiver 30 is coupled to the decoder 32 such that, in operation, the signal received at the receiver 30 is sent to the decoder 32. The decoder 32 is configured to decode the received signal (i.e., the information encoded into an appropriate Multimedia Container by the TS encoder 24) and to process the decoded information. The decoder 32 is coupled to the TV 10 such that decoded and further processed information may be displayed on the TV 10 to the user 12. The decoder 32 is also coupled to the storage 34 such that decoded and further processed information may be sent from the decoder 32 to the storage 34 and stored at the storage 34.

FIG. 5 is a process flow chart showing certain steps of an embodiment of a method of providing semantic bookmarks 102 for the TV program 100, as performed by the elements of the network shown of FIG. 1.

At step s2, the EPG service module 14 sends metadata corresponding to the TV program 100 (e.g., the start time 104 and end time 106 of the TV program 100, the type of the TV program 100, genre of the TV program 100, cast and crew names of the program 100, the parental advisory rating of the TV program 100, etc.) to the semantic label binder 16 and to the media analysis module 18.

At step s4, using the metadata received from the EPG service module 14, the semantic label binder 16 selects a set of semantic labels relating to the TV program 100, i.e., semantic labels that are likely to be appropriate for describing content events in the TV program 100. For example, a set of semantic labels may be selected for the TV program depending on the type of the TV program 100.

At step s6, the semantic label binder 16 sends the selected semantic labels to the media analysis module 18.

At step s8, the media analysis module 18 receives the television feed for the TV program 100 from the service operator 2.

At step s10, using the metadata received from the EPG service module 14, the media analysis module 18 analyses the television feed to detect content events within the TV program 100. The analysis performed by the media analysis module 18 is any appropriate type of analysis such that content events of the TV program 100 may be detected. For example, a conventional process of analysing audio, video or close caption (sub-title) text to detect content events may be used. For example, a period of increased sound levels in a televised soccer match tends to be indicative of a content event (e.g., a goal). Also, for example, an instance of a completely black screen in a movie tends to be indicative of a content event (e.g., a cut from one scene to the next).

At step s12, the media analysis module 18 maps the set of the semantic labels (received from the semantic label binder 14 at step s6) onto the set of content events (detected/created at step s10). The mapping of the semantic labels onto the set of content events is performed using any appropriate process. For example, a probabilistic approach to mapping may be implemented. For example, in a televised soccer match, sound levels above a predefined threshold level, for longer than a predefined length of time may be more indicative of one type of content event (e.g., a goal) than a different type of content event (e.g., a foul). An example process by which content events may be detected and identified is disclosed in “A fusion scheme of visual and auditory modalities for event detection in sports video”, Min Xu, Ling-Yu Duan, Chang-Sheng Xu, Qi Tian, Institute for Infocomm Research, 21 Heng Mui Keng Terrace, Singapore 119613, which is incorporated herein by reference.

Thus, at step s12 a set of semantic bookmarks 102 for the TV program 100 are created.

Also at step s12, a URI can be added to the semantic bookmark. For example, the media analysis module 18 may automatically generate a URI for a content event and include that URI in the semantic bookmark that represents that content event. In other embodiments, a URI may be included in a semantic bookmark in a different way. For example, a URI of a semantic bookmark may be generated and included in a semantic bookmark manually by an editor/author of the semantic bookmarks, as described in more detail later below.

At step s14, the media analysis module 18 sends the semantic bookmarks 102 to the database 20 where they are stored.

At step s16, the bookmark authoring module 22 retrieves the semantic bookmarks 102 stored in the database 20.

At step s18, the semantic bookmarks 102 may be reviewed, filtered, and edited by the bookmark author 6 via the bookmark authoring module 22. In this embodiment, the process of reviewing, filtering, and editing semantic bookmarks 102, as performed by the bookmark author 6, may include adding one or more further semantic bookmarks 102 or deleting one or more of the semantic bookmarks 102.

Also, at step s18, the bookmark author 6 may generate one or more URIs for a content event and include those URIs in a relevant semantic bookmark. Existing URIs may be reviewed, filtered, edited, and deleted by the bookmark author 6 via the bookmark authoring module 22.

Thus, at step s18 an updated set of semantic bookmarks 102 for the TV program 100 is created.

At step s20, the bookmark authoring module 22 sends the updated semantic bookmarks 102 to the database 20 where they are stored.

At step s22, the TS encoder 24 receives the television feed for the TV program 100 from the service operator 2.

At step s24, the TS encoder 24 retrieves the updated semantic bookmarks 102 stored in the database 20.

At step s26, the TS encoder 24 encodes the television feed for the TV program 100 and the updated semantic bookmarks 102. The encoded television feed and updated semantic bookmarks 102 are then inserted into an appropriate Multimedia Container. Examples of a Multimedia Container include the MPEG Transport Stream, Flash Video, and QuickTime. The MPEG Transport Stream may comprise, for example, audio elementary streams, video elementary streams, closed-caption/subtitle elementary streams, and a Program Address table. The updated semantic bookmarks 102 and television feed may be encoded using any appropriate process. For example, the updated semantic bookmarks 102 can be inserted into the private user data (e.g., as a sequence header extension in an MPEG-2 video stream) in a MPEG transport stream and be properly extracted by the receiving device (e.g., the set top box 8) that is configured to recognize the header and payload of the semantic bookmarks. The TV feed, as it may comprise text, audio, video, and other types of information (such as graphical composition and animation information) may be separately carried by other types of elemental streams in the same transport stream, such as the video, audio, text, and private user data elemental streams.

At step s28, the TS encoder 24 sends the encoded Multimedia Container to the transmitter 25.

At step s29, the transmitter 25 transmits the encoded Multimedia Container to the set-top box 8.

At step s30, the set-top box 8 decodes the received Multimedia Container, and the content is displayed to the user 12 (on the TV 10). Also, in this embodiment, the received and decoded television feed and semantic bookmark information decoded by the set-top box 8 are stored in the storage 34 of the set-top box 8.

Thus, a method of providing semantic bookmark information for a TV program 100 is provided.

The user 12 may perform semantic trick play on the content displayed to him. An example method by which the user 12 may perform this semantic trick play will now be described with reference to FIG. 6.

FIG. 6 is a process flow chart showing certain steps of an example method by which the user 12 may perform this semantic trick play on the content displayed to him (i.e., on the displayed TV program 100). In this example, the user 12 performs trick play to skip backwards in the displayed TV content. In other examples, the user 12 may perform a different type of trick play to navigate through the TV program 100.

At step s32, the TV program 100 is displayed to the user 12 on the TV 10.

At step s34, the user presses the “skip back” button on a remote control for the set-top box 8. In this example, the “skip back” command is an instruction that playback of the TV program 100 jumps back to, and begins from, a point in the TV program 100 that is earlier than the current point in the TV program 100.

At step s36, set top-box 8 receives the “skip back” command.

At step s38, using the current point in the TV program 100 (i.e., the current playback position in the TV program 100), the set-top box 8 identifies a most recent start time 104 for a semantic bookmark 102. In other words, the start time 104 for the most recent semantic bookmark 102 is identified. In this embodiment, this step s38 is performed by the set-top box 8 looking up the most recent start time 104 for a semantic bookmark 102 in the decoded television feed and semantic bookmark information that is stored in the storage 34 of the set-top box 8 at step s30 above.

At step s40, the set-top box 8 accesses the stored information (e.g., decodes the Multimedia Container which comprises the updated semantic bookmarks 102 and television feed) from the start time 104 identified at step s38 (i.e., the start time 104 for the most recent semantic bookmark 102).

At step s42, the set-top box 8 replays the TV program 100 to the user 12 on the TV 10 from the start time 104 identified at step s38.

At step s44, some or all of the information relating to the most recent semantic bookmark 102 (e.g., the semantic label 112 and the event description 114) is displayed to the user 12 on the TV 10, for example as an overlay to the TV program 100.

Thus, an example method by which the user 12 may perform this semantic trick play on the TV program 100 being displayed to him is provided.

An advantage provided by the above described method of providing semantic bookmark information for the TV program 100 is that the performance of semantic trick play by the user 12 is enabled. The user 12 is advantageously enabled to navigate through the media presentation, this navigation being dependent upon salient features of the content as opposed to arbitrary demarcation points. This tends to enable the user 12 to locate a desired playback position in the media presentation relatively quickly (i.e., compared to using conventional trick play methods). Furthermore, a user 12 wishing to return to a segment of particular interest in a media presentation tends to be able to do so whilst avoiding the conventional hit-or-miss methods, which tend to be frustrating. For example, a user 12 may record a news broadcast that contains new segments on a number of different topics but only be interested in a relatively small number of those topics. In such a scenario, the user 12 is easily able to skip through news segments to find those segments of interest (as indicated by the semantic label or event description of those segments).

A further advantage provided by the above described method of providing semantic bookmark information for the TV program 100 is that the semantic bookmarks may be used by multiple users 12 (using their respective TVs 10 and set-top boxes 8). In particular, multiple users 12 may perform semantic trick play on the TV program 100 independently from one another, and at the same time as one another, using only a single set of semantic bookmarks. The Multimedia Container in which the encoded television feed and semantic bookmark information is embedded may easily be transmitted to any number of users 12.

The media analysis module 18 may automatically create semantic bookmarks 102 for the TV program 100. These semantic bookmarks may be reviewed, filtered, and edited by the human bookmark author. In certain embodiments, the semantic bookmarks 102 are only created manually (e.g., by a human). Also, in other certain embodiments the semantic bookmarks 102 are only created automatically (e.g., by a media analysis module 18).

In embodiments in which the semantic bookmarks 102 are only generated automatically, semantic bookmarks 102 tend to be generated more quickly than if those bookmarks are reviewed by a bookmark author. Furthermore, a bookmark author is not used in such embodiments, and therefore costs tend to be reduced.

In embodiments in which the semantic bookmarks 102 are only generated manually, no media analysis module 18 is required. Also, the semantic bookmarks 102 created tend to be more accurate than those generated using only automatic means (e.g., by the media analysis module 18).

In embodiments in which the semantic bookmarks 102 are generated automatically and manually reviewed, filtered, and edited by a bookmark author, the semantic bookmarks 102 tend to be generated more quickly than if those bookmarks were created manually. Furthermore, the created semantic bookmarks 102 tend to be more accurate than those generated using only automatic means. Furthermore, the workload on the bookmark author tends to be reduced compared to embodiments in which the semantic bookmarks 102 are only generated manually. Thus, cost tends to be reduced.

In the above embodiments, the semantic bookmark information is advantageously embedded with the TV program content within a multimedia stream. Thus, the semantic bookmark information tends to be easy to transmit with the TV program content. Furthermore, if the multimedia container containing the embedded semantic bookmark information is received by a set-top box that not capable of utilising the semantic bookmark information, that set-top box may discard or ignore the embedded semantic bookmark information and decode the TV program 100 as normal.

An advantage provided by a URI inserted in a semantic bookmark is that, for example when using a companion device (e.g., a tablet computer) to browse semantic bookmarks (such as in the below described alternative embodiment), the user experience tends to be enhanced. For example, a greater number of options and facilities may be provided to the user 12. For example, when watching the TV 10, the user 12 is also able to access rich web content related to a content event of the TV program (as indicated by the URI). An advantage of having a URI indicate (i.e., link to) an external web server is that content stored at the location indicated by the URI (i.e., content stored at the external server) can be updated at any, e.g., a later time, without modifying the content of the semantic label. Thus, it tends to be advantageously possible to create rich (web) content for a TV program after that program has been aired and thereby enhance recorded TV watching and repeat TV watching experiences.

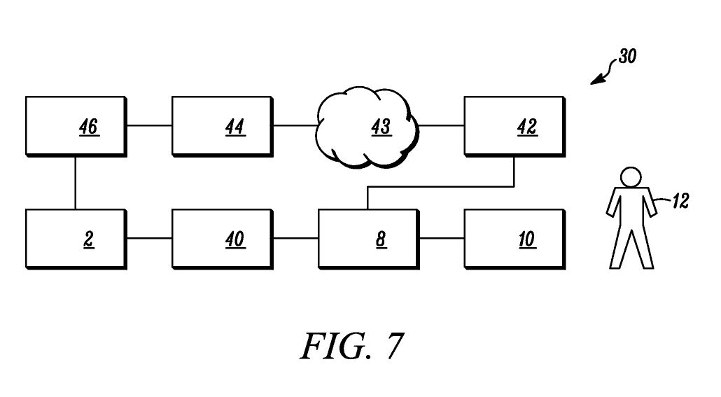

FIG. 7 is a schematic illustration (not to scale) of a further example of a network, hereinafter referred to as “the further network” and indicated in FIG. 7 by the reference numeral 30, in which a further embodiment of a method of providing semantic bookmark information for the TV program 100 is implemented.

The further network 30 comprises the service operator 2, the set-top box 8, the TV 10, the user 12, a further cable head-end 40, a tablet computer 42, the Internet 43, a web server 44, and a content provider 46.

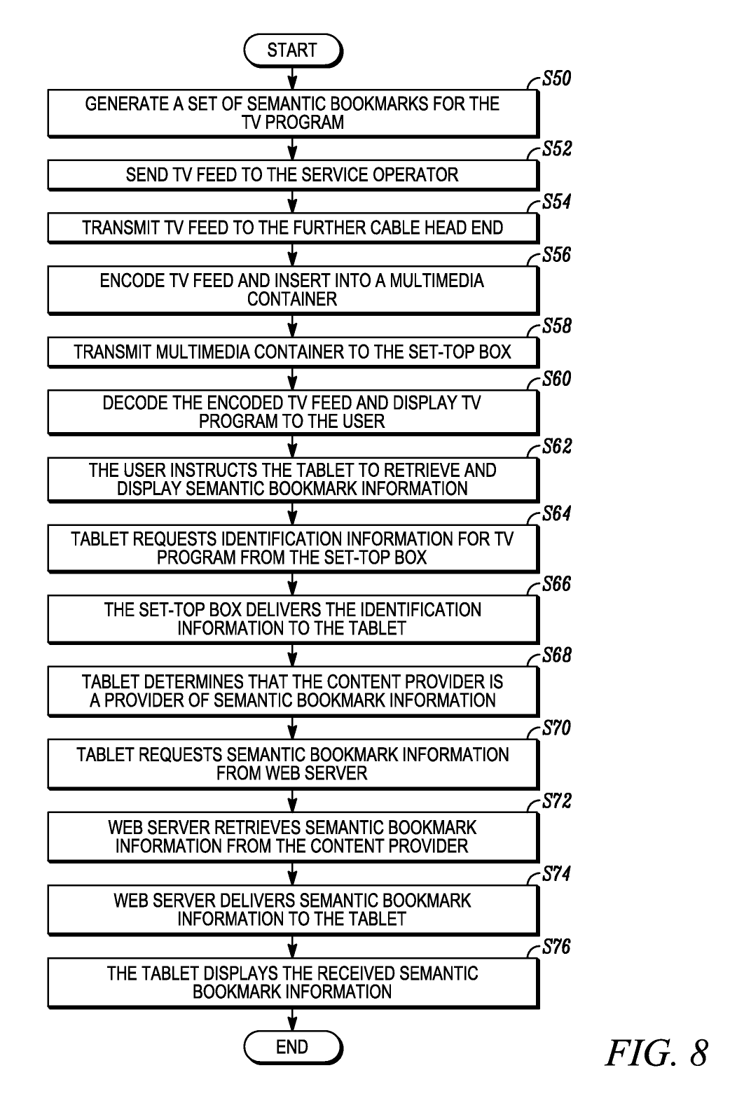

The further embodiment of the method of providing semantic bookmark information for the TV program 100, as performed by the elements of the further network 30, is described in more detail below with reference to FIG. 8.

In this example, the service operator 2, the set-top box 8, the TV 10, and the user 12 are as described above with reference to FIG. 2.

The further cable head end 40 is a conventional cable head end, i.e., a conventional facility for receiving, processing, and re-distributing television signals (e.g., the television feed). The tablet computer 42 has access to the Internet 43 (e.g., Wi-Fi Internet access). The web server 44 is a conventional web server for delivering content, e.g., to the tablet computer 42, that can be accessed through the Internet 43. The content provider 46 is the provider (e.g., the maker) of the TV program. The user 12 is a user of the set-top box 8, TV 10, and the tablet computer 42.

In the further network 30 the service operator 2 is coupled to the content provider 46 such that, in operation, the TV program 100 is provided from the content provider 46 to the service operator 2 for transmission.

Furthermore, the service operator 2 is coupled to the further cable head-end 40 such that, in operation, the service operator 2 provides the television feed to the further cable head end 40.

In operation, the further cable head-end 40 receives the television feed from the service operator 2 and processes the received feed in a conventional way.

The further cable head end 40 is coupled to the set-top box 8 such that, in operation, the processed television feed is sent (encoded in an appropriate Multimedia Container) from the further cable head end 40 to the set-top box 8.

In operation, the set-top box 8 (which is as described in more detail above with reference to FIG. 4) receives the Multimedia Container from the further cable head end 40 and decodes the Multimedia Container. The set-top box 8 is coupled to the TV 10 such that, in operation, the decoded TV program 100 is displayed to the user 12 on the TV 10.

Furthermore, in the further network 30, the set-top box 8 is coupled to the tablet computer 42 such that, in operation, information may be sent between the set-top box 8 and the tablet computer 42, as described in more detail later below with reference to FIG. 8.

In addition to being coupled to the set-top box 8, the tablet computer 42 is coupled to the web server 44 (via the Internet 43 in this embodiment) such that, in operation, requests for web pages may be sent from the tablet computer 42 to the web server 44, and such that the requested web pages may be delivered from the web server 44 to the tablet computer 42.

In addition to being coupled to the tablet computer 42, the web server 44 is coupled to the content provider 46 such that the web server 44 may access and retrieve information provided by the content provider 46.

FIG. 8 is a process flow chart showing certain steps of a further embodiment of a method of providing semantic bookmarks 102 for the TV program 100, as performed by the elements of the further network 30.

At step s50, the content provider 46 generates a set of semantic bookmarks 102 for the TV program 100. This set of semantic bookmarks 102 is stored by the content provider 46. The generated semantic bookmarks may comprise a semantic label, a description, and one or more URIs for the relevant content event.

At step s52, the content provider 46 sends the television feed for the TV program 100 to the service operator 2.

At step s54, the service operator 2 sends the television feed for the TV program 100 to the further cable head end 40.

At step s56, the further cable head end 40 encodes the received television feed for the TV program 100 and inserts the encoded television feed into an appropriate Multimedia Container.

At step s58, the further cable head end 40 sends the Multimedia Container to the set-top box 8.

At step s60, the set-top box 8 decodes the encoded television feed received in the Multimedia Container, and the TV program 100 is displayed to the user 12 (on the TV 10).

At step s62, the user 12 instructs the tablet computer 42 to retrieve and display semantic bookmarks 102 relating to the TV program 100 currently being displayed on the TV 10.

At step s64, the tablet computer 42 sends a request (e.g., via Wi-Fi) to the set-top box 8 for information by which the TV program 100 may be identified (e.g., a channel ID, a program ID, etc.)

At step s66, the requested identification information is delivered (e.g., via Wi-Fi) from the set-top box 8 to the tablet computer 42.

At step s68, using the identification information for the TV program 100, the tablet computer 42 looks up (e.g., in a web-based look-up directory) a party that provides the semantic bookmark information for the TV program 100. In this embodiment, the party that provides the semantic bookmarks 102 for the TV program 100 is the content provider 46.

At step s70, the tablet computer 42 sends a request for the desired semantic bookmarks 102 to the web server 44 (i.e., via the Internet 43). In this embodiment, this request comprises identification information for the TV program 100 and identification information for the party that is providing the semantic information for the TV program 100 (i.e., the content provider 46).

At step s72, the web server 44 retrieves semantic bookmarks 102 for the TV program 100 from the content provider 46.

At step s74, the web server 44 sends the semantic bookmarks 102 to the tablet computer 42 via the Internet 43.

At step s76, the semantic bookmarks 102 for the TV program 100 are displayed to the user 12 on the tablet computer 42. For example, a list of the semantic bookmarks 102 for the TV program 100 may be displayed to the user 12 on the tablet computer 42. The tablet computer 42 may display both semantic bookmark information as well as additional relevant content stored at the locations indicated by the URIs.

Thus, a method of providing semantic bookmark information for the TV program 100 is provided.

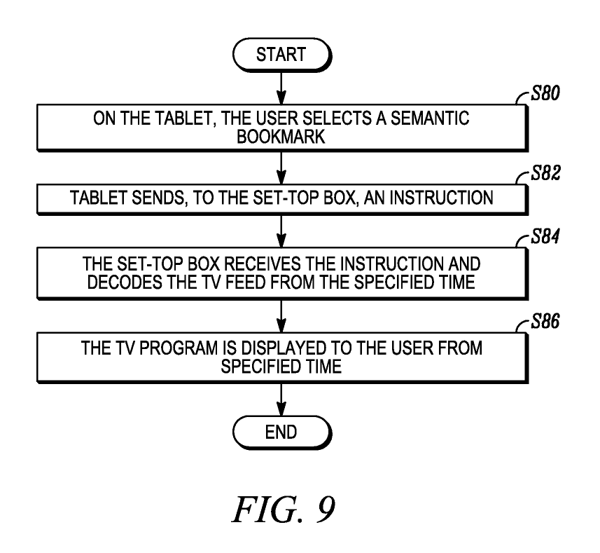

The user 12 may perform semantic trick play on the TV program 100 using the tablet computer 42 (and the semantic bookmarks 102). An example method by which the user 12 may perform this semantic trick play using the tablet computer 42 will now be described with reference to FIG. 9.

FIG. 9 is a process flow chart showing certain steps of an example method by which the user 12 may perform this semantic trick play, using the tablet computer 42, on the content displayed to him.

In this example, the user 12 performs trick play to skip backwards in the displayed TV program 100. The TV program 100 is being played to the user 12 on the TV 10. Also, semantic bookmarks 102 relating to the TV program 100 have been delivered to the tablet computer 42, as described in more detail above with reference to FIG. 8.

At step s80, on the tablet computer 42, the user 12 selects a semantic bookmark 102 of the TV program 100 that he wishes to begin playback of the TV program 100 from. For example, the particular semantic bookmark 102 may be selected by the user 12 based upon the semantic label 112 or upon the event description information 114 of that semantic bookmark 102. In this embodiment, because the user 12 performs trick play to skip backwards in the displayed TV content, the start time 104 of the selected semantic bookmark 102 in the TV program 100 is before the current time in the TV program 100.

At step s82, the tablet computer 42 sends an instruction to the set-top box 8 to jump back to, and begin playback from, the start time 104 of the selected semantic bookmark 102.

At step s84, set top-box 8 receives the instruction from the tablet computer 42 and decodes the television feed from the specified time (i.e., from the start time 104 of the selected semantic bookmark 102).

At step s86, the set-top box 8 replays the TV program 100 to the user 12 on the TV 10 from the specified time.

Thus, an example method by which the user 12 may perform this semantic trick play using the tablet computer 42 is provided.

In addition to those advantages mentioned above for the first embodiment, the above described further embodiment of the method of providing semantic bookmark information for the TV program advantageously tends to provide that, even if the set-top box 8 of the user 12 is not capable of handling semantic bookmark information, the user 12 is still able to perform semantic trick play. In particular, the user 12 may download semantic bookmark information for a TV program onto a tablet computer 42 (or laptop, mobile phone, or other such device) and perform semantic trick play using the downloaded bookmarks without the set-top box 8 needing to process the semantic bookmark information.

A further advantage provided by the above described further embodiment is that semantic bookmarks for a TV program may be provided (by any party) completely separately from the provision of the TV program itself. Furthermore, any number of different parties may provide semantic bookmark information for a TV program, and a user 12 may select from which party or parties he wishes to retrieve the semantic bookmarks.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method of processing a multimedia presentation, the method comprising:
using the multimedia presentation, generating, by a processor, a bookmark for a point or segment within the multimedia presentation; and
encoding, by an encoding device operatively connected to the processor, the multimedia presentation and the bookmark into a multimedia container.

2. The method according to claim 1 further comprising transmitting, by a transmitter operatively connected to the encoding device, the multimedia container to an end user device.

3. The method according to claim 1 wherein generating the bookmark comprises:
analysing the multimedia presentation to determine a demarcation for a content event, the content event being within the multimedia presentation; and
including the determined demarcation in the bookmark.

4. The method according to claim 1 wherein generating the bookmark comprises:
analysing the multimedia presentation to determine a semantic label for a content event, the content event being within the multimedia presentation; and
including the determined semantic label in the bookmark.

5. The method according to claim 1 wherein generating the bookmark comprises:
analysing the multimedia presentation to determine a description for a content event, the content event being within the multimedia presentation; and
including the determined description in the bookmark.

6. The method according to claim 1 wherein generating the bookmark comprises:
determining a Universal Resource Identifier for a content event, the content event being within the multimedia presentation; and
including the determined Universal Resource Identifier in the bookmark.

7. The method according to claim 1 wherein generating the bookmark is performed automatically by the processor.

8. The method according to claim 7 further comprising using an input received as a result of a human reviewing, filtering, or editing an output of the processor.

9. A method for an end-user device to receive a media presentation, the method comprising:
receiving, by the end-user device, a multimedia container, the multimedia container having encoded therein the multimedia presentation and a bookmark for a point or segment within the multimedia presentation;
decoding, by the end-user device, the multimedia container; and
processing, by the end-user device, the decoded contents of the multimedia container thereby allowing a user of the end-user device to perform trick play on the multimedia presentation using the bookmark.

10. A method of processing a multimedia presentation, the method comprising:
using the multimedia presentation, generating, by a processor, a bookmark for a point or segment within the multimedia presentation; and
providing over the Internet, by a server operatively connected to the processor, the bookmark, the bookmark being for use by a first end-user device, the use being during reception by a second end-user device of the multimedia presentation encoded in a multimedia container;
wherein the bookmark comprises a demarcation for a content event within the multimedia presentation.

11. The method according to claim 10 wherein the first end-user device and the second end-user device are different types of end-user devices.

12. The method according to claim 10:
wherein the first end-user device is a device selected from the group consisting of: a computer and a mobile communications device; and
wherein the second end-user device is a set-top box.

13. The method according to claim 10 wherein the bookmark further comprises a feature selected from the group consisting of: a semantic label for the content event, a description of the content event, and a Universal Resource Identifier for the content event.

14. The method according to claim 10 wherein generating the bookmark comprises, using the processor, automatically:
analysing the multimedia presentation to detect the content event in the multimedia presentation; and
determining the demarcation for the content event.

15. The method according to claim 14 wherein generating the bookmark further comprises using an input received as a result of a human reviewing, filtering, or editing an output of the automatic means.

16. Apparatus for processing a multimedia presentation, the apparatus comprising:
a processor configured to, using the multimedia presentation, generate a bookmark for a point or segment within the multimedia presentation; and
an encoding device operatively connected to the processor and configured to encode the multimedia presentation and the bookmark into a multimedia container.

17. The apparatus according to claim 16 further comprising a transmitter operatively connected to the encoder and configured to transmit the multimedia container to an end-user device.

18. The apparatus according to claim 16 wherein the bookmark comprises a feature selected from the group consisting of: a demarcation for a content event within the multimedia presentation, a semantic label for a content event within the multimedia presentation, a description of a content event within the multimedia presentation, and a Universal Resource Identifier for a content event within the multimedia presentation.

19. The apparatus according to claim 16 wherein the processor comprises a media analysis module configured to automatically:
analyse the multimedia presentation to detect a content event in the multimedia presentation; and
determine the demarcation for the content event.

20. The apparatus according to claim 19 further comprising an interface arranged to allow a human to review, filter, or edit an output of the media analysis module.

21. An end-user device comprising:
a receiver configured to receive a multimedia container, the multimedia container having encoded therein the multimedia presentation and a bookmark for a point or segment within the multimedia presentation; and
a decoder operatively connected to the receiver and configured to decode the multimedia container and process the decoded contents of the multimedia container, thereby allowing a user of the end-user device to perform trick play on the multimedia presentation using the bookmark.

22. Apparatus for processing a multimedia presentation, the apparatus comprising:
a processor configured to, using the multimedia presentation, generate a bookmark for a point or segment within the multimedia presentation; and
a server operatively connected to the processor and configured to provide over the Internet the bookmark, the bookmark being for use by a first end-user device, the use being during reception by a second end-user device of the multimedia presentation encoded within a multimedia container;
wherein the bookmark comprises a demarcation for a content event within the multimedia presentation.

23. The apparatus according to claim 22 wherein the first end-user device and the second end-user device are different types of end-user devices.

24. The apparatus according to claim 22:
wherein the first end-user device is a device selected from the group consisting of: a computer and a mobile communications device; and
wherein the second end-user device is a set-top box.

25. The apparatus according to claim 22 wherein the bookmark further comprises a feature selected from the group consisting of: a semantic label for the content event, a description of the content event, and a Universal Resource Identifier for the content event.

26. The apparatus according to claim 22 wherein the processor comprises a media analysis module configured to automatically:
analyse the multimedia presentation to detect the content event in the multimedia presentation; and
determine the demarcation for the content event.

27. The apparatus according to claim 26 further comprising an interface arranged to allow a human to review, filter, or edit an output of the media analysis module.
